(19) United States
(12) Patent Application Publication
(10) Pub. No.: US 2026/0085763 A1
(43) Pub. Date: Mar. 26, 2026

(54) VENT VALVE AND VEHICLE BATTERY PACK HAVING THE SAME

(71) Applicant: FORD GLOBAL TECHNOLOGIES, LLC, Dearborn, MI (US)

(72) Inventors: Fei GAO, Hefei (CN); Robin ZHOU, Nanjing (CN)

(21) Appl. No.: 19/336,593

(22) Filed: Sep. 23, 2025

(30) Foreign Application Priority Data
Sep. 26, 2024 (CN) 202411349345.8

(51) Int. Cl. F16K 15/14; B60L 50/64; H01M 50/249; H01M 50/30

(52) U.S. Cl. CPC F16K 15/148; H01M 50/394; B60L 50/64; H01M 50/249; H01M 2220/20

(57) ABSTRACT

A vent valve and a vehicle battery pack having the same are provided. The vent valve includes a main body including a first end, a second end, and a through hole extending from the first end to the second end; a breathable membrane connected to the first end and covering the through hole; an upper cover covering the breathable membrane; and a first opening and a second opening in communication with each other. The first opening and the second opening are relatively offset in at least one of an axial direction or a circumferential direction. Compared with existing solutions, the technical solution of the present disclosure can provide enhanced protection for internal structures, such as the breathable membrane, further reduce the overall structural complexity of the vent valve, and enhance its functional durability, thereby increasing user satisfaction.

### CROSS-REFERENCE TO RELATED APPLICATIONS

This disclosure claims priority to Chinese Application No. 202411349345.8, which was filed Sep. 26, 2024 and is incorporated by reference in its entirety.

### TECHNICAL FIELD

This disclosure generally relates to a vent valve and a vehicle battery pack having the same.

### BACKGROUND

In the prior art, vent valves can be used for gas/pressure exchange between enclosed spaces and external environment to achieve desired pressure balance. The vent valves have various structures and applications in diverse scenarios, one of which involves an electrified vehicle. The electrified vehicle has developed rapidly due to their advantages in reducing fuel consumption and exhaust emissions. A typical electrified vehicle includes a battery pack. The vent valve is also widely used in the battery pack.

There are various vent valve configurations in the prior art. For example, patent application US20160036025 discloses a pressure relief valve for a housing of a battery, which includes a support element, a breathable and waterproof membrane, and a tensioning frame that presses the breathable and waterproof membrane against the support element. Spring elements on the tensioning frame further restrict the movement through a cover.

The inventors of the present disclosure recognize that there is still room for decreasing the overall structural complexity and increasing functional durability of the vent valves of the prior art.

### SUMMARY

The present disclosure summarizes aspects of the embodiments and should not be used to limit the claims. Other implementations are contemplated in accordance with the techniques described herein, as will be apparent to those skilled in the art upon examination of the following drawings and detailed description, and such implementations are intended to be within the scope of this disclosure.

To address technical issues such as those mentioned above, the inventors of the present disclosure have recognized the need for a vent valve and a vehicle battery pack having the same that can further reduce the overall structural complexity of the vent valve and enhance its functional durability, thereby improving user satisfaction.

An aspect of the present disclosure provides a vent valve, including:
a main body including a first end, a second end, and a through hole extending from the first end to the second end;
a breathable membrane connected to the first end and covering the through hole;
an upper cover covering the breathable membrane; and
a first opening and a second opening in communication with each other, wherein the first opening and the second opening are relatively offset in at least one of an axial direction or a circumferential direction.

In an embodiment of the present disclosure, at least one of the first opening and the second opening is located on the main body of the vent valve. In another embodiment of the present disclosure, at least one of the first opening and the second opening is located on the upper cover. In yet another embodiment of the present disclosure, at least one of the first opening and the second opening is located between the main body and the upper cover.

According to an embodiment of the present disclosure, the upper cover includes a cover body and a first flange extending from the cover body toward the main body, the first opening is located between the first flange and the main body, the upper cover further includes a baffle disposed radially inward of the first opening, and the second opening is located on an end of the baffle adjacent to the cover body.

According to an embodiment of the present disclosure, the upper cover includes a cover body and a first flange extending from the cover body toward the main body, the first opening is located between the first flange and the main body, the main body further includes a second flange disposed radially inward of the first opening and extending toward the cover body, and the second opening is located between the second flange and the cover body.

According to an embodiment of the present disclosure, the upper cover includes a cover body and a first flange extending from the cover body toward the main body, the first opening is located between the first flange and the main body and extends circumferentially along a first segment of the upper cover, the upper cover further includes a baffle disposed radially inward of the first opening, the second opening is located on the baffle and extends circumferentially along a second segment of the upper cover, and the first segment and the second segment are circumferentially offset from each other.

According to an embodiment of the present disclosure, the upper cover includes a cover body and a first flange extending from the cover body toward the main body, the first opening is located between the first flange and the main body and extends circumferentially along a first segment of the upper cover, the main body further includes a second flange disposed radially inward of the first opening and extending toward the cover body, the second opening is located on the second flange and extends circumferentially along a second segment of the upper cover, and the first segment and the second segment are circumferentially offset from each other.

According to an embodiment of the present disclosure, the main body further includes an engagement portion extending circumferentially outward between the first end and the second end, and the engagement portion includes a first connection face for connecting an airtightness testing fixture.

According to an embodiment of the present disclosure, the main body further includes a support portion located on a first side of the engagement portion and configured to connect the breathable membrane, and a connection portion located on a second side of the engagement portion, and the breathable membrane has a first state, in which the breathable membrane conforms to the support portion and seals the through hole, and a second state, in which the breathable membrane disengages from the through hole.

According to an embodiment of the present disclosure, the support portion further includes a second fluid passage directly communicating the through hole with the second opening in the second state.

According to an embodiment of the present disclosure, the support portion includes a first support portion includes multiple holes, a second support portion surrounding the first support portion and smoothly transitioning outward, and a third support portion surrounding the second support portion and includes the second fluid passage, wherein, in the first state, the breathable membrane conforms to the first support portion and the second support portion and is connected to the third support portion, and wherein, in the second state, the breathable membrane is relatively separated from the first support portion and the second support portion, thereby the second fluid passage directly communicates the through hole with the second opening.

According to an embodiment of the present disclosure, the third support portion is connected to the second support portion via one or more suspension ribs spaced apart from each other.

According to an embodiment of the present disclosure, the engagement portion has a radial dimension larger than a radial dimension of the upper cover.

According to an embodiment of the present disclosure, the first connection face is oriented radially outward.

According to an embodiment of the present disclosure, the first connection face has a first groove, and a first sealing ring is partially disposed within the first groove.

According to an embodiment of the present disclosure, the upper cover further includes a first snap-fit portion, and the first snap-fit portion is engageable with a second snap-fit portion on the main body.

According to an embodiment of the present disclosure, the second side of the engagement portion is provided with a second groove surrounding and spaced apart from the connection portion, and a second sealing ring is partially disposed within the second groove.

According to an embodiment of the present disclosure, the second sealing ring includes a plurality of spaced-apart protruding ribs thereon.

According to an embodiment of the present disclosure, the first end of the main body includes a mesh support frame for supporting the breathable membrane, and the second end is connected to a protective plate having a plurality of holes.

According to an embodiment of the present disclosure, the upper cover includes an outer protrusion configured to engage a first tool, and a third groove configured to engage a second tool is formed in the outer protrusion.

Another aspect of the present disclosure also provides a vent valve including:
a main body including:
   a first end;
   a second end;
   a through hole extending from the first end to the second end; and
   an engagement portion located between the first end and the second end and extending circumferentially outward, wherein the engagement portion includes a first connection face for connecting an airtightness testing fixture;
a breathable membrane connected to the first end; and
an upper cover covering the breathable membrane.

Yet another aspect of the present disclosure provides a vehicle battery pack including a vent valve of any one of the above embodiments.

### BRIEF DESCRIPTION OF THE FIGURES

In order to better understand the present disclosure, reference can be made to the embodiments shown in the following drawings. The components in the drawings may not necessarily be drawn to scale, and relevant components may be omitted, or in some cases, the scale may have been enlarged to emphasize and clearly illustrate the novel features described in this disclosure. Additionally, as known in the art, system components can be arranged differently. Further in the figures, like reference numbers refer to like parts throughout the different figures.

FIG. 1 illustrates a schematic diagram of a vehicle including a vehicle battery pack according to one or more embodiments of the present disclosure;

FIG. 2 illustrates a top view of a vehicle battery pack including a vent valve according to one or more embodiments of the present disclosure;

FIG. 3 illustrates an exploded view of the vent valve according to one or more embodiments of the present disclosure;

FIG. 4 illustrates a perspective view of the vent valve from an upper cover side according to one or more embodiments of the present disclosure;

FIG. 5 illustrates a perspective view of the vent valve from a main body side according to one or more embodiments of the present disclosure;

FIG. 6 illustrates a perspective view of the vent valve with the upper cover removed according to one or more embodiments of the present disclosure;

FIG. 7 illustrates a perspective view of a main body of the vent valve according to one or more embodiments of the present disclosure;

FIG. 8 illustrates an exploded perspective view of a breathable membrane of the vent valve according to one or more embodiments of the present disclosure;

FIG. 9 illustrates a top view of a breathable membrane of the vent valve according to one or more embodiments of the present disclosure;

FIG. 10 illustrates a top view of a breathable membrane of the vent valve according to another one or more embodiments of the present disclosure;

FIG. 11 illustrates a top view of a breathable membrane of the vent valve according to yet another one or more embodiments of the present disclosure;

FIG. 12 illustrates a perspective cross-sectional view of a main body and a breathable membrane of the vent valve according to one or more embodiments of the present disclosure;

FIG. 13 illustrates an axial cross-sectional view of a main body of the vent valve according to one or more embodiments of the present disclosure;

FIG. 14 illustrates an axial cross-sectional view of a peripheral portion of the vent valve according to one or more embodiments of the present disclosure;

FIG. 15 illustrates an axial cross-sectional view of the vent valve according to one or more embodiments of the present disclosure, with a breathable membrane in a first state;

FIG. 16 illustrates an axial cross-sectional view of the vent valve according to one or more embodiments of the present disclosure, with a breathable membrane in a second state;

FIG. 17 illustrates an axial cross-sectional view of the vent valve and an airtightness testing fixture connected thereto according to one or more embodiments of the present disclosure;

FIG. 18 illustrates an axial cross-sectional view of a vent valve according to another one or more embodiments of the present disclosure;

FIG. 19 illustrates a top view of a portion associated with a first flange and a baffle of a vent valve according to another one or more embodiments of the present disclosure;

FIG. 20 illustrates a top view of a portion associated with a first flange and a second flange of a vent valve according to another one or more embodiments of the present disclosure; and

FIG. 21 illustrates an axial cross-sectional view of a vent valve according to yet another one or more embodiments of the present disclosure.

### DETAILED DESCRIPTION

Embodiments of the present disclosure are described below. However, it is to be understood that the disclosed embodiments are merely examples and other embodiments may take various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce embodiments not expressly shown or described. The combinations of features shown herein provide representative embodiments for typical disclosures. However, various combinations and modifications of the features consistent with the teachings of the present disclosure may be desired for certain particular applications or implementations.

In this document, when an element or part is referred to as being “on . . . ”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on . . . ”, “directly bonded to”, “directly connected to”, or “directly coupled to” another element or part, the intervening elements or parts may not be present. Other words used to describe the relationship between elements should be interpreted in a like fashion.

As mentioned in the background, the inventors recognize that there is still room for optimizing the technical solution of the vent valve of the prior art. There is a need for a vent valve and a vehicle battery pack having the same, which should be able to further reduce the overall structural complexity of the vent valve and increase the durability of its functions, thereby increasing user satisfaction. Based on these issues in the prior art, the inventors of the present disclosure provides a vent valve and a vehicle battery pack having the same in one or more embodiments, believing that it can solve one or more issues in the prior art.

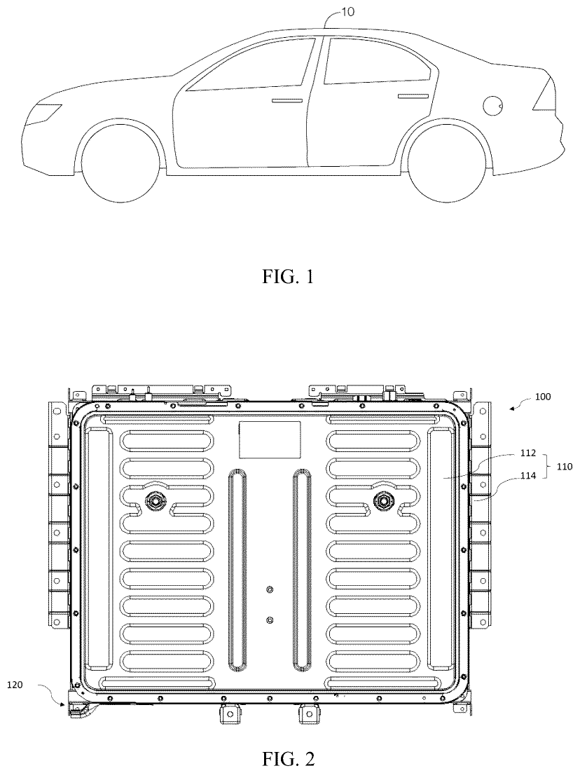

Firstly, FIG. 1 illustrates a schematic diagram of a vehicle 10 including a battery pack 100 according to one or more embodiments of the present disclosure. It should be understood that in the context of the present disclosure, the vehicle 10 implementing the present disclosure may refer to any vehicle containing a vehicle battery pack, including but not limited to fossil fuel vehicles, electric vehicles (such as plug-in hybrid electric vehicles (PHEVs), fully hybrid electric vehicles (FHEVs), light hybrid electric vehicles (MHEVs), or battery electric vehicles (BEVs)), or even ships, aircraft, etc. The vehicle 10 may include components related to mobility, such as an engine, an electric motor, a transmission, a suspension, a drive shaft, and/or wheels, and the like. The vehicle 10 may be non-autonomous, semi-autonomous (e. g., some conventional movement functions autonomously controlled by the vehicle) or autonomous (e. g., motion functions autonomously controlled by the vehicle without direct input from the user).

FIG. 2 is a top view of a battery pack 100 that may be incorporated into the above-described electrified vehicle 10. As shown in the figure, the battery pack 100 includes a housing 110 composed of an upper cover plate 112 and a lower tray 114, and a plurality of reinforcing structures and connection positions can be provided around the housing 110, which are omitted here and will not be marked and described one by one for brevity. The battery pack 100 generally communicates with external air through an air guide device 120, and a vent valve connected to the battery pack below the air guide device 120. It can be understood that, in other embodiments, the vent valve can be directly connected to the battery pack without an additional air guide device. The construction of the vent valve will be explained below with reference to further drawings. Those skilled in the art should appreciate that although the structure of the vent valve is discussed herein in the context of a vehicle battery pack, various vent valves of the present disclosure are broadly applicable to any suitable scenario where it is necessary to maintain pressure balance inside and outside a container.

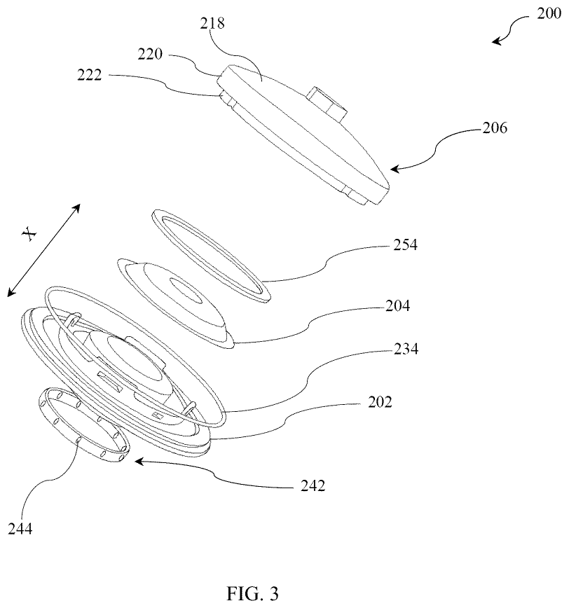

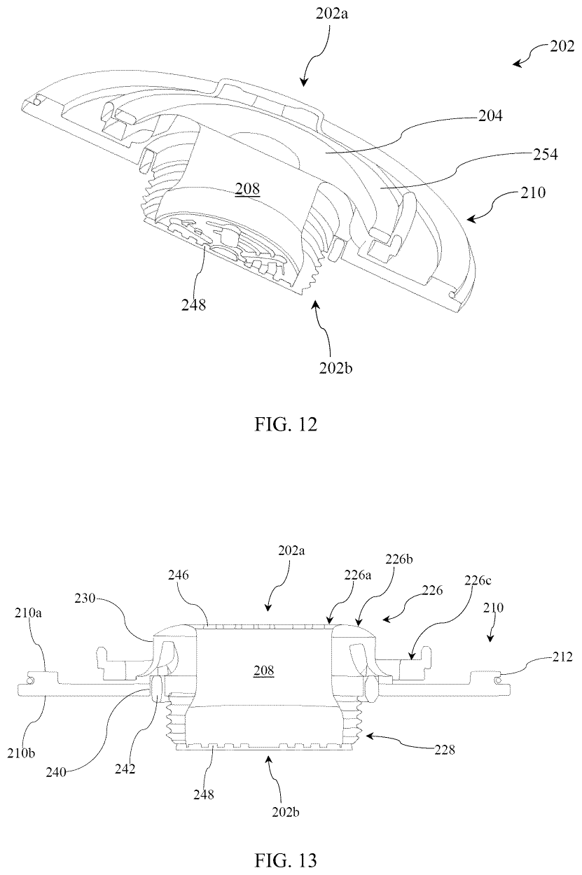

Referring generally to FIGS. 3 to 16, as shown in the figures, one aspect of the present disclosure provides a vent valve 200 including a main body 202, an upper cover 206, a breathable membrane 204, a first opening 214, and a second opening 224. The main body 202 has a first end 202a and a second end 202b, with a through hole 208 penetrating from the first end 202a to the second end 202b. The breathable membrane 204 is connected to the first end 202a and covers the through hole 208, as shown in FIG. 12. The upper cover 206 generally covers the breathable membrane 204 to provide protection. For example, the upper cover 206 can be connected to the main body 202 through a snap-fit or other suitable structure to cover the breathable membrane 204. The first opening 214 and the second opening 224 are in communication with each other, with one of them communicated with the external environment and the other communicated with the breathable membrane 204. Among them, the first opening 214 and the second opening 224 are relatively offset in at least one of an axial direction X or a circumferential direction Y.

In the description of the present disclosure, the vent valve 200 includes the first opening 214 and the second opening 224, in other words, means that the first opening 214 and the second opening 224 may be located between the upper cover 206 and the main body 202 of the vent valve 200 and/or on at least one of them. This includes but is not limited to at least one of the first opening 214 and the second opening 224 being located on the main body 202; at least one of the first opening 214 and the second opening 224 being located on the upper cover 206; at least one of the first opening 214 and the second opening 224 being located between the main body 202 and the upper cover 206. In some embodiments, the locations of the first opening 214 and the second opening 224 may be further described to include the following several situations: both the first opening 214 and the second opening 224 being located on the upper cover 206; both being located on the main body 202; both being located between the upper cover 206 and the main body 202; one being located on the main body 202 and the other on the upper cover 206; one being located between the upper cover 206 and the main body 202 and the other on the upper cover 206; and one being located between the upper cover 206 and the main body 202 and the other on the main body 202; etc. Those skilled in the art will appreciate that the positions of the first opening 214 and the second opening 224 may be flexibly arranged according to the specific structure of different vent valves 200 without departing from the scope of the concepts of the present disclosure.

In the context of the present disclosure, the term “axial direction X” is intended to describe the direction of the line connecting the first end 202a and the second end 202b. The description “the first opening 214 and the second opening 224 are relatively offset in the axial direction X” is intended to mean that the first opening 214 and the second opening 224 are at different positions, or in other words, are displaced relative to each other in the axial direction X. The term “circumferential direction Y” is intended to describe a direction around the outer periphery of a component. It should be understood that the outer periphery of the component is not limited to the circular contour shown in the figures, but may include any other possible shape, such as, but not limited to, square, pentagonal, hexagonal, etc. The description “the first opening 214 and the second opening 224 are relatively offset in the circumferential direction Y” is intended to mean that: using the center position of the component as the projection center, the projections of the first opening 214 and the second opening 224 onto the outer periphery of the component are at different angular positions, in other words, are angularly displaced relative to each other. Further, the description “the first opening 214 and the second opening 224 are relatively offset in at least one of the axial direction X or the circumferential direction Y” is intended to include: the first opening 214 and the second opening 224 being relatively offset in the axial direction X, the two being relatively offset in the circumferential direction Y, or the two being relatively offset in both the axial direction X and the circumferential direction Y.

In addition, at least a portion of the breathable membrane 204 in this disclosure may include any existing or potentially developed material film that allows gas to pass through while blocking liquid from passing through, including but not limited to PU (polyurethane) film, TPU (thermoplastic polyurethane) film, and EPTFE (polytetrafluoroethylene) film, etc., and its thickness is not specifically limited here.

In the embodiment of the present disclosure, the first opening 214 and the second opening 224 are provided on the vent valve 200, and the first opening 214 and the second opening 224 are relatively offset in at least one of the axial direction X or the circumferential direction Y. In the structure of the vent valve 200 formed, the first opening 214 and the second opening 224 are offset in the axial and/or circumferential directions from each other, which allows the airflow to freely flow between the two openings, while preventing the splashing water flow, mud dust, and debris generated during early testing verification or vehicle driving, or the water flow sprayed during cleaning of the housing where the vent valve 200 is located from directly contacting the breathable membrane 204 and other components inside the upper cover 206. This further reduces or prevents the accumulation of liquids, dirt, and debris on the breathable membrane 204 and other components, which may affect breathability and related functions, and further reduces or prevents the possible contact of high-speed water flow and other pollutants on the breathable membrane 204 and other components, thereby reducing the overall structural complexity of the vent valve and improving functional durability, consequently increasing user satisfaction.

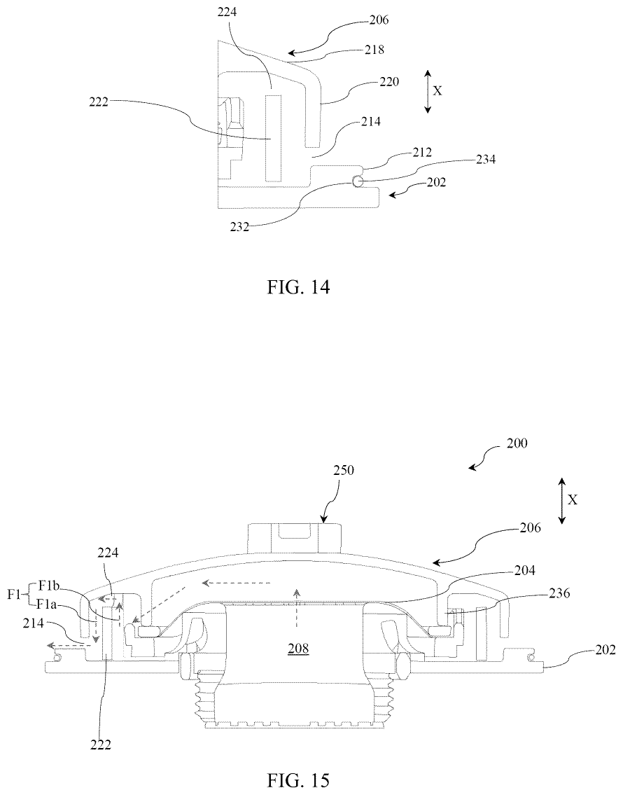

Referring to FIG. 3 and simultaneously to FIG. 14, in some embodiments, the upper cover 206 further includes a cover body 218 and a first flange 220. The first flange 220 is bent from the cover body 218 and extends toward the main body 202. In this embodiment, the first opening 214 is located between the first flange 220 and the main body 202 and is formed by a gap between them. The gap can form a closed shape around the vent valve 200, or it can only be around a portion of the vent valve 200. The upper cover 206 further includes a baffle 222, which is disposed radially inward of the first opening 214 (i.e. closer to the center of the upper cover 206). The second opening 224 is formed on the end of the baffle 222 adjacent to the cover body 218, as shown on the upper end in FIG. 14. The second opening 224 can be one opening or several openings spaced apart from each other. In this embodiment, the first opening 214 and the second opening 224 formed are offset from each other in the axial direction X. The first flange 220 and the baffle 222 form a staggered shielding effect for the internal breathable membrane 204, protecting the breathable membrane 204 while allowing airflow between the two openings. It can be understood that the first opening 214 and/or the second opening 224 can be continuous circumferential openings or discontinuous multiple openings spaced apart from each other.

Referring to FIG. 4, according to some embodiments, the upper cover 206 is provided with an outer protrusion 250 configured to engage a first tool, such as but not limited to an external hex wrench or socket. Furthermore, the outer protrusion 250 has a third groove 252 configured to engage a second tool, such as but not limited to an Allen wrench. The outer protrusion 250 and the third groove 252 can be adapted to different disassembly tools to facilitate flexible disassembly and assembly of the upper cover 206.

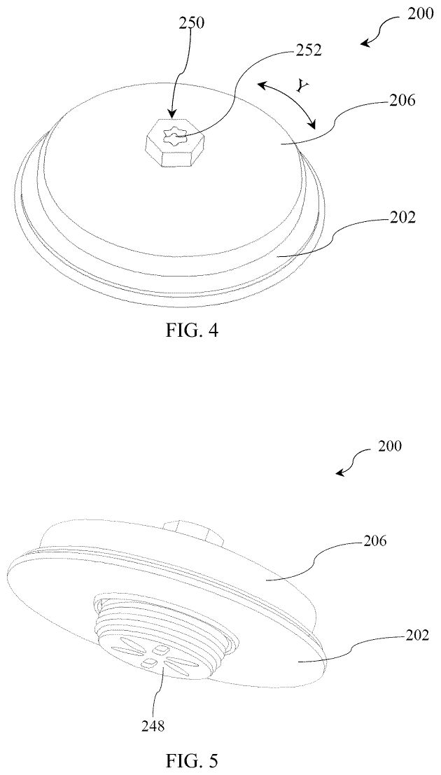

Referring to FIGS. 5 and 7, according to some embodiments, a mesh support frame 246 is mounted on the first end 202a of the main body 202 to support the breathable membrane 204, providing sufficient breathability while providing good support for the breathable membrane 204. When the breathable membrane 204 moves under the action of gas pressure, the mesh support frame 246 provides support to the breathable membrane 204, preventing excessive movement and potential contact. A protective plate 248 with multiple through holes is mounted on the second end 202b of the main body 202. The through holes in the protective plate 248 can block debris that may be present inside the housing (e.g., housing 110 of the battery pack 100) to which the vent valve 200 is mounted from entering and blocking the through hole 208, thereby enhancing the functional durability of the vent valve 200.

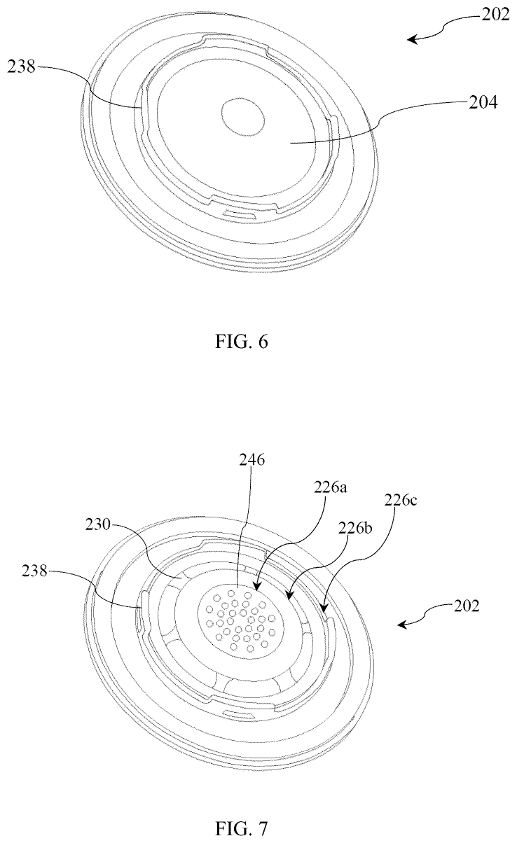

Referring to FIGS. 6 and 7, and simultaneously to FIG. 15, in some embodiments, the upper cover 206 further includes a first snap-fit portion 236, and the main body 202 includes a second snap-fit portion 238. The first snap-fit portion 236 and the second snap-fit portion 238 are engageable, for example, via a snap-fit connection, to facilitate quick installation and disassembly between the upper cover 206 and the main body 202. The figures illustrate four snap-fit locations, but in practical applications, the number of snap-fit locations may be adjusted to be more or fewer as needed. Moreover, the connection is not limited to snap-fit connection. For example, it may be a threaded connection.

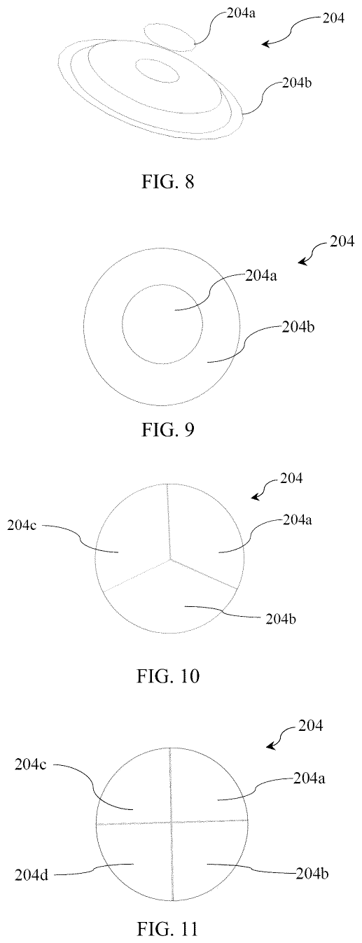

Next, referring to FIGS. 8 and 9, in some embodiments, the breathable membrane 204 includes a first portion 204a and a second portion 204b. The breathability of the first portion 204a is different from that of the second portion 204b. That is, the breathability of one portion is higher than the other portion. For example, but not limited to, one portion may be breathable while the other is non-breathable. In this embodiment the breathable membrane 204 is partitioned and different breathability levels are set for each partition. This enables the vent valve 200 to be better adapted to various working conditions/usage scenarios. For instance, by customizing the breathability of different partitions, the corresponding partition can produce intended multi-stage morphological changes at various predetermined pressures. This includes, but not limited to, localized deformation, expansion, rupture, etc., achieved through variations in breathability/thickness across partitions, thereby achieving correspondingly different ventilation efficiencies and pressure exchange effects as required. Consequently, diversified functions are realized with a compact structure. Furthermore, selecting different breathability levels for different partitions facilitates the use of more complexly manufactured waterproof-breathable materials only in specific areas without compromising performance. The first portion 204a and the second portion 204b may be connected together, for example but not limited to, via welding, adhesion, or being integrally formed.

Continuing to refer to FIGS. 8 and 9, and simultaneously to FIGS. 6 and 7, in the illustrated embodiment, the first portion 204a of the breathable membrane 204 covers at least a part of the through hole 208, and the second portion 204b is disposed surrounding the first portion 204a. This arrangement allows the vent valve 200 to be easily customized for different working conditions/usage scenarios. For example, when applied to a vehicle battery pack, to meet different breathability requirements of various packs, only the first portion 204a of different sizes needs to be replaced to achieve the desired breathability. This further simplifies the overall manufacturing process.

In further embodiments, the breathability of the first portion 204a of the breathable membrane 204 is greater than that of the second portion 204b surrounding the first portion 204a. Positioning the first portion 204a with greater breathability to cover the through hole 208 and inside the second portion 204b allows its breathability to be fully utilized and results in more balanced stress distribution across the entire breathable membrane 204. Additionally, since the portion with greater breathability typically involves a more complex manufacturing process, this configuration can also simplify the overall fabrication process to some extent. According to several yet further embodiments, the centrally located first portion 204a of the breathable membrane 204 includes a waterproof and breathable membrane, and the peripheral second portion 204b includes a non-breathable, elastically expandable material. For example, the first portion 204a may include PU (polyurethane) film, TPU (thermoplastic polyurethane) film, EPTFE (expandedpolytetrafluoroethylene) film, etc., while the second portion 204b may include materials that are not breathable but have simple manufacturing processes, such as but not limited to, rubber film. Consequently, the size of the first portion 204a can be set only in the central, critical ventilation area as needed. This enables further simplification of the overall manufacturing process and eliminates potential internal condensation issues associated with excessively large breathable membrane.

Moreover, in other embodiments, both the first portion 204a and the second portion 204b of the breathable membrane 204 may both cover at least a part of the through hole 208, with the second portion 204b being adjacent to the first portion 204a. The first portion 204a and the second portion 204b can be arranged in any possible shape configuration, such as being split equally left and right, one larger and one smaller side-by-side, etc. The shape of the boundary between them can be set as needed, for example, straight, curved, zigzag, etc. The first portion 204a and the second portion 204b may be integral or independently formed. This allows achieving the desired effects for different working conditions/usage scenarios, such as rupturing, deforming or the like at different set pressures to achieve intended multi-stage vent effects.

Furthermore, in some embodiments, the thickness of the second portion 204b of the breathable membrane 204 may be greater than the thickness of the first portion 204a. By setting different thicknesses between partitions, it is possible to flexibly customize the deformation effect of the membrane while achieving the desired breathability, so as to achieve different multi-stage vent effects. According to the structure and design requirements, the first portion 204a and the second portion 204b can be integrally formed by the same or different materials, or bonded or welded together.

As shown in FIG. 10, according to some other embodiments of the present disclosure, the breathable membrane 204 may further include a third portion 204c with different breathability from the first portion 204a and the second portion 204b. The first portion 204a, the second portion 204b, and the third portion 204c may all cover at least a part of the through hole 208. In some embodiments, the first portion 204a, the second portion 204b, and the third portion 204c may be independent of each other, such that the rupture or expansion of one of them does not affect the other two. In other embodiments, the three portions can also be as a whole. For example, they can be connected together by bonding, welding, integral molding, etc. The first portion 204a, the second portion 204b, and the third portion 204c are configured with different breathability to provide different forms of expansion, lifting, or rupture under different pressure conditions, thereby achieving customizable multi-stage vent rates. This can achieve the desired effects for different working conditions/usage scenarios. In some embodiments, the breathable membrane including the first portion and the second portion with different breathability can be modularly configured according to the required valve breathability for different vehicle models, battery configurations, etc. FIG. 11 further illustrates an example scenario where the breathable membrane 204 includes a first portion 204a, a second portion 204b, a third portion 204c, and a fourth portion 204d with different breathability. It should be understood that, depending on the specific working conditions/application scenarios, more or fewer partitions may be provided without departing from the concepts of this disclosure.

Referring to FIGS. 12 and 15, in some embodiments, the breathable membrane 204 may be weldably connected to the main body 202 via a weld ring 254. For example, the weld ring 254 may be positioned at the outer periphery of the breathable membrane 204 and form a substantially annular, continuous ring. The breathable membrane 204 is connected to the main body 202 via welding, thereby achieving a better sealing effect. In other embodiments, the connection between the weld ring 254 and the breathable membrane 204 may be discontinuous. This allows the formation of multiple circumferentially separated channels at a certain pressure that permit air to flow directly without passing through the breathable membrane 204, enabling different gas exchange efficiencies at different pressures. In some further embodiments, the breathable membrane 204 may be snap-fit to the main body 202. For instance, at the edge of the breathable membrane 204, it may be snapped/clamped at a predetermined position on the main body 202 via snap-fit elements, such as, but not limited to, elastic clips, elastic rings, form-fitting columnar ends, annular grooves and form-fitting retaining rings, etc. Alternatively, a support frame may be provided at the outer periphery of the breathable membrane 204. The support frame and the corresponding snap-fit portions on the main body 202 are form-fit to achieve connection. Thereby, more convenient installation and replacement can be realized.

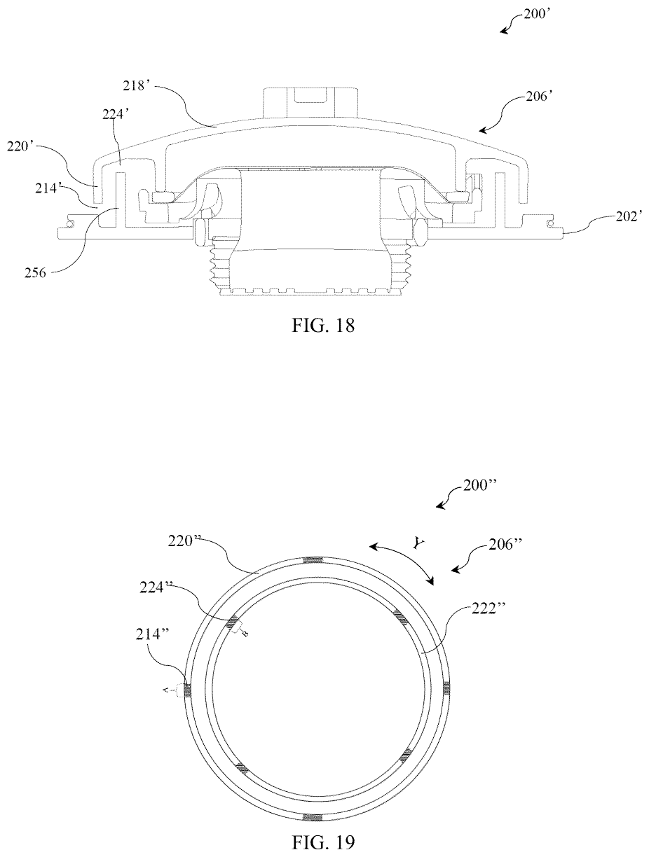

Referring to FIGS. 13 and 14, in several embodiments, the main body 202 further includes an engagement portion 210. The engagement portion 210 extends circumferentially outward between the first end 202a and the second end 202b, forming an outer periphery, for example, of a flange shape. A first connection face 212 for connecting an airtightness testing fixture 216 is further provided on the engagement portion 210 (refer to the connected state in FIG. 17). Providing the first connection face 212 on the engagement portion 210 facilitates connecting the airtightness testing fixture 216 to the vent valve 200. This conveniently enables airtightness inspection operations inside the housing to which the vent valve 200 is mounted, such as housing 110 of the battery pack 100. It allows convenient airtightness inspection of both the applied battery pack and the valve while the valve itself is in the installed state, which is advantageous for further efficient and accurate airtightness detection.

Referring to FIGS. 14 and 17, in some embodiments, the radial dimension of the engagement portion 210 is larger than the radial dimension of the upper cover 206. Thereby, the first connection face 212 on the engagement portion 210 is exposed outside, evading obstructing the airtightness testing fixture 216 for connection and airtightness testing. Further, the first connection face 212 may face radially outward, i.e., in a direction substantially perpendicular to the axial direction. This structural arrangement allows the first connection face 212 and the inner wall of the airtightness testing fixture 216 to mutually form-fitting, facilitating the installation and fixation of the airtightness testing fixture 216.

Continuing to refer to FIG. 14, a first groove 232 is provided on the first connection face 212. For example, a substantially annular groove is formed circumferentially around the engagement portion 210. The vent valve 200 further includes a first sealing ring 234, for example, a substantially annular sealing ring disposed circumferentially around the engagement portion 210. The first sealing ring 234 is partially disposed within the first groove 232, facilitating better airtight engagement between the airtightness testing fixture 216 and the first connection face 212 of the vent valve 200, and enabling more effective internal airtightness testing.

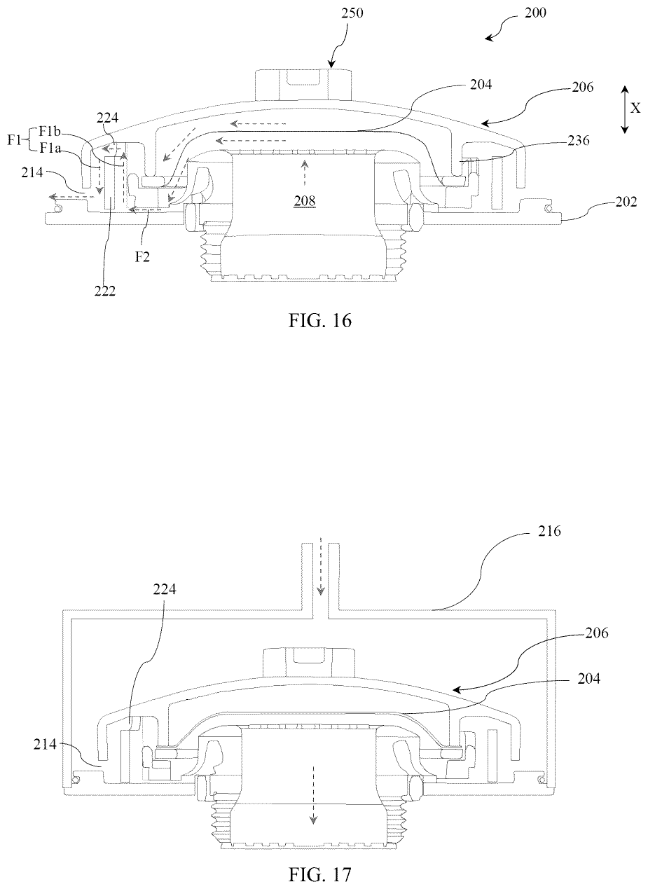

Next, referring to FIGS. 15 and 16, and simultaneously to FIG. 13, in several embodiments, the main body 202 further includes a support portion 226 and a connection portion 228. The support portion 226 is located on a first side 210a of the engagement portion 210 and is configured to connect the breathable membrane 204. The connection portion 228 is located on a second side 210b of the engagement portion 210 and is configured for connection to a housing to be installed, such as the housing 110 of the battery pack 100. The breathable membrane 204 may be in a first state as shown in FIG. 15, where the internal-external pressure differential is low. In the first state, the breathable membrane 204 conforms to the support portion 226 and seals the through hole 208. Gas exchange between the exterior of the vent valve 200 (e.g., the external environment) and the interior of the vent valve 200 (e.g., inside the housing 110 of the battery pack 100) occurs only through the corresponding breathability of the breathable membrane 204, where gas exchange efficiency remains at a relatively low level. The breathable membrane 204 may further be in a second state as shown in FIG. 16, where the internal-external pressure differential is high. In the second state, the breathable membrane 204 expands and disengages from the through hole 208, establishing direct communication between the exterior and interior of the vent valve 200, resulting in a higher gas exchange efficiency. In other words, when the gas pressure differential between the two sides of the vent valve 200 reaches a threshold, regardless of which side has higher pressure, the breathable membrane 204 will bulge into the second state. This causes the breathable membrane 204 to separate relative to the through hole 208, forming a direct air passage channel and achieving higher vent efficiency. Thereby, the vent valve 200 achieves multi-stage ventilation efficiency under different pressure ranges to match varying operating conditions. Furthermore, in some embodiments, where the first portion 204a of the breathable membrane 204 has high breathability and the second portion 204b has low or no breathability, different sizes of the first portion 204a will cause the overall lifting pressure exerted by the internal-external pressure differential on the breathable membrane 204 to vary. Therefore, the size of the first portion 204a can be set differently according to different requirements (e.g., different battery sizes and models), thereby adjusting the lifting pressure. That is, adjusting the pressure that triggers the transition of the breathable membrane 204 between the first state and the second state. This enables the on-demand setting of the state transition pressure.

As shown in FIGS. 15 and 16, in some embodiments, the interior of the vent valve 200 includes a first fluid passage F1 communicating the first opening 214 to the breathable membrane 204. The first fluid passage F1 includes a first segment Fla and a second segment Fib at a certain angle between the flow directions of them, e.g., including but not limited to 180 degrees. The bend portion between them forms the second opening 224. This configuration eliminates potential contacts caused by liquid or debris directly influencing the breathable membrane 204 and other internal components. The support portion 226 further includes a second fluid passage F2. As shown in FIG. 16, in the second state, the second fluid passage F2 directly communicates the through hole 208 with the second opening 224, i.e., communicates to the first fluid passage F1. This achieves direct communication between the through hole 208 and the external environment in the second state, and the resulting higher ventilation efficiency.

Continuing to refer to FIGS. 15 and 16, and simultaneously to FIGS. 12 and 13, according to several embodiments, the support portion 226 includes a first support portion 226a, a second support portion 226b, and a third support portion 226c. The first support portion 226a covers the through hole 208 and has multiple holes. The second support portion 226b is disposed surrounding the first support portion 226a and transitions smoothly outward. The third support portion 226c is disposed surrounding the second support portion 226b and has the second fluid passage F2. The third support portion 226c is at least partially spaced apart from the breathable membrane 204. In the first state shown in FIG. 15, the breathable membrane 204 conforms to the first support portion 226a and the second support portion 226b and is connected to the third support portion 226c. In the second state shown in FIG. 16, the breathable membrane 204 is relatively separated from the first support portion 226a and the second support portion 226b, thereby the second fluid passage F2 directly connects the through hole 208 to the second opening 224. The smooth transition design of the second support portion 226b allows the breathable membrane 204 to connect to the support portion 226 with a certain tension, providing good support and connection for the breathable membrane 204. The arrangement of the third support portion 226c facilitates the direct connection between the through hole 208 and the first fluid passage F1 via the second fluid passage F2 in the second state.

Returning to FIG. 13, according to some embodiments, a plurality of suspension ribs 230 spaced apart from each other are disposed between the second support portion 226b and the third support portion 226c. The second support portion 226b is connected to the third support portion 226c via these suspension ribs 230, which is also shown in the perspective view of FIG. 7. The number of suspension ribs 230 can be adjusted as needed, e.g., one or more, and is not limited to the six shown in FIG. 7. Thereby, the third support portion 226c can be suspension-connected to the second support portion 226b, forming the second fluid passage F2 between the third support portion 226c and the engagement portion 210.

In the embodiment shown in FIG. 13, a second groove 240 is provided on the second side 210b of the engagement portion 210. The second groove 240 is disposed surrounding the connection portion 228 and spaced apart from it. The vent valve 200 further includes a second sealing ring 242 partially located within the second groove 240. This forms an airtight seal between the vent valve 200 and the housing to which it is mounted, such as the housing 110 of the battery pack 100. Spacing the second sealing ring 242 apart from the connection portion 228 also prevents the edge of the connection portion 228 or the through hole in the housing/component to be connected from compressing the second sealing ring 242 during installation. In several further embodiments, the second sealing ring 242 has a plurality of spaced-apart protruding ribs 244 thereon, as shown in FIG. 3, to achieve stable fixation and fitting of the second sealing ring 242 within the second groove 240.

Referring to the cross-sectional view shown in FIG. 18, in other embodiments of the present disclosure, a vent valve 200′ is provided. The vent valve 200′ may include an upper cover 206′ and a main body 202′. The upper cover 206′ includes a cover body 218′ and a first flange 220′ extending from the cover body 218′ toward the main body 202′. A first opening 214′ is located between the first flange 220′ and the main body 202′. The main body 202′ further includes a second flange 256 disposed radially inward of the first opening 214′ and extending toward the cover body 218′. A second opening 224′ is located between the second flange 256 and the cover body 218′. The first opening 214′ and the second opening 224′ are relatively offset in the axial direction X. In this structure, the second flange 256 is formed by the upward extension of the main body 202′. The mutual cooperation of the first flange 220′ and the second flange 256 creates an axially staggered shielding effect for the breathable membrane and other internal components, achieving gas flow between the two openings while protecting the breathable membrane and other internal components by an alternative way.

Referring to the schematic diagram in FIG. 19, in other embodiments of the present disclosure, a vent valve 200″ is provided. The structure of unnumbered parts can refer to the drawings of embodiments related to the vent valve 200. The vent valve 200″ may include an upper cover 206″ and a main body. The upper cover 206″ includes a cover body and a first flange 220″ extending from the cover body toward the main body. A first opening 214″ is located between the first flange 220″ and the main body and extends circumferentially along a first segment A of the upper cover 206″. The upper cover 206″ further includes a baffle 222″ disposed radially inward of the first opening 214″. A second opening 224″ is located on the baffle and extends circumferentially along a second segment B of the upper cover 206″, with the first segment A and the second segment B being circumferentially offset from each other. In this structure, openings are configured on different circumferential segments of the first flange 220′ and the baffle 222″ to complement each other so as to create a circumferentially staggered shielding effect for the breathable membrane and other internal components, achieving gas flow between the two openings while protecting the breathable membrane and other internal components by an alternative way.

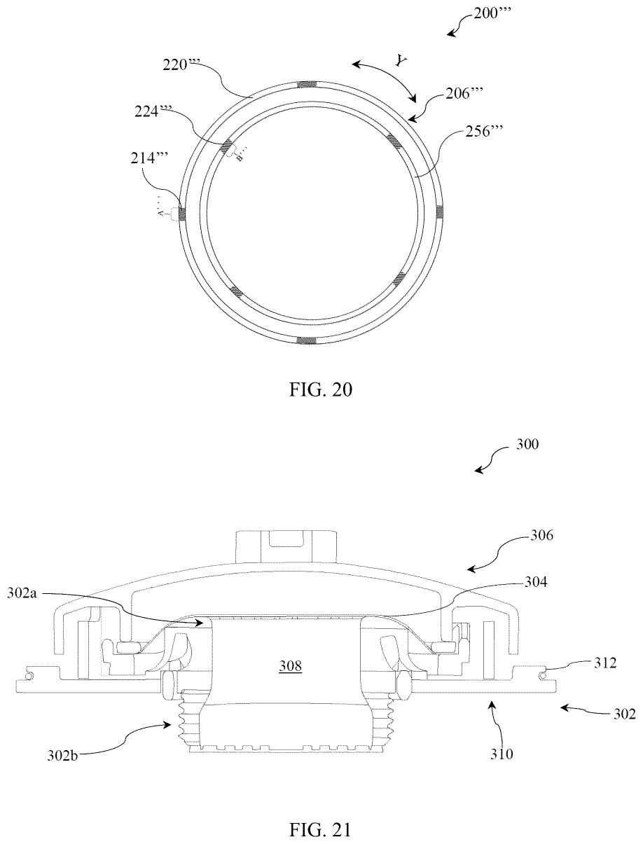

Referring to the schematic diagram in FIG. 20, other embodiments of the present disclosure provide a vent valve 200′″. The structure of unnumbered parts can refer to the drawings of embodiments related to the vent valve 200′. The vent valve 200′″ may include an upper cover 206′″ and a main body. The upper cover 206′″ includes a cover body and a first flange 220′″ extending from the cover body toward the main body. A first opening 214′″ is located between the first flange 220′″ and the main body 202 and extends circumferentially along a first segment A′″ of the upper cover 206′″. The main body 202 further includes a second flange 256′″ disposed radially inward of the first opening 214′″ and extending toward the cover body 218. A second opening 224′″ is located on the second flange 256′″ and extends circumferentially along a second segment B′″ of the upper cover 206′″, with the first segment A′″ and the second segment B′″ being circumferentially offset from each other. In this structure, the second flange 256′″ is formed by the upward extension of the main body. Openings are configured on different circumferential segments of the first flange 220′″ and the second flange 256′″ to complement each other so as to create a circumferentially staggered shielding effect for the breathable membrane and other internal components, achieving gas flow between the two openings while protecting the breathable membrane and other internal components by an alternative way.

According to another aspect of the present disclosure, a vent valve 300 is provided. Referring to FIG. 21, it includes a main body 302, a breathable membrane 304, and an upper cover 306. The main body 302 has a first end 302a, a second end 302b, and an engagement portion 310. The engagement portion 310 is located between the first end 302a and the second end 302b and extends circumferentially outward. A through hole 308 extends through the main body 302 from the first end 302a to the second end 302b. The breathable membrane 304 is connected to the first end 302a and at least partially covers the through hole 308. The upper cover 306 covers the breathable membrane 304. The engagement portion 310 has a first connection face 312 for connecting an airtightness testing fixture. Providing the first connection face 312 on the engagement portion 310 facilitates connecting the airtightness testing fixture to the vent valve 300, conveniently enabling airtightness inspection operations inside the housing to which the vent valve 300 is mounted, such as the housing 110 of the battery pack 100. In the prior art, when testing the airtightness of a battery pack, it is often necessary to first remove the vent valve, then inflate and test the airtightness of the battery pack through the opening used for valve installation. However, it is difficult to confirm the seal integrity of the battery pack after the vent valve is reinstalled. The vent valve 300 allows convenient airtightness inspection of the applied battery pack while the valve itself is in the installed state, which is advantageous for more convenient and accurate determination of seal integrity.

According to a further aspect of the present disclosure, referring to FIG. 2, a vehicle battery pack 100 is provided, including the vent valve 200, 200″, 200′″, or 300 as described in any of the above embodiments. Likewise, it should be understood that, to the extent not mutually conflicting, all implementations, features, and advantages described above for the vent valves 200, 200″, 200′″, or 300 according to the present disclosure equally apply to the vehicle battery pack 100 according to this further aspect. That is to say, all embodiments and variations thereof described above are directly transferable and incorporable herein. For the sake of brevity of this disclosure, it will not be reiterated here.

In conclusion, compared with the prior art, the present disclosure proposes a vent valve and a vehicle battery pack having the same. The technical solution of the present disclosure, relative to the prior art, can provide better protection for the breathable membrane and other internal components, further reduce the overall structural complexity of the vent valve, and enhance its functional durability, thereby improving user satisfaction.

It should be understood that, on the premise of technical feasibility, the technical features listed above for different embodiments can be combined with each other to form other embodiments within the scope of the present disclosure.

In this disclosure, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-mentioned embodiments are possible examples of implementations of the present disclosure and are given only for the purpose of enabling those skilled in the art to clearly understand the principles of the present invention. It should be understood by those skilled in the art that the above discussion to any embodiment is only illustrative, and is not intended to imply that the disclosed scope of the embodiments of the present disclosure (including claims) is limited to these examples; and under the overall concept of the present invention, the technical features in the above embodiments or different embodiments can be combined with each other to produce many other changes in different aspects of embodiments of the present invention that is not provided in detailed description for the sake of brevity. Therefore, any omission, modification, equivalent replacement, optimization, etc. made within the spirit and principle of the embodiment of the present invention shall be included in the scope of protection claimed by the present invention.

What is claimed is:

1. A vent valve, comprising:
a main body comprising a first end, a second end, and a through hole extending from the first end to the second end;
a breathable membrane connected to the first end and covering the through hole;
an upper cover positioned over the breathable membrane; and
a first opening and a second opening in communication with each other, wherein the first opening and the second opening are relatively offset in at least one of an axial direction or a circumferential direction.

2. The vent valve of claim 1, wherein the upper cover comprises a cover body, a first flange extending from the cover body toward the main body, and a baffle disposed radially inward of the first opening.

3. The vent valve of claim 2, wherein the first opening is located between the first flange and the main body, and the second opening is located on an end of the baffle adjacent to the cover body.

4. The vent valve of claim 1, wherein the upper cover comprises a cover body, a first flange extending from the cover body toward the main body, and a second flange disposed radially inward of the first opening and extending toward the cover body.

5. The vent valve of claim 4, wherein the first opening is located between the first flange and the main body, and the second opening is located between the second flange and the cover body.

6. The vent valve of claim 1, wherein the upper cover comprises a cover body, a first flange extending from the cover body toward the main body, and a baffle disposed radially inward of the first opening.

7. The vent valve of claim 6, wherein the first opening is located between the first flange and the main body and extends circumferentially along a first segment of the upper cover, and the second opening is located on the baffle and extends circumferentially along a second segment of the upper cover, and further wherein the first segment and the second segment of the upper cover are circumferentially offset from one another.

8. The vent valve of claim 1, wherein the upper cover comprises a cover body, a first flange extending from the cover body toward the main body, and a second flange disposed radially inward of the first opening and extending toward the cover body.

9. The vent valve of claim 8, wherein the first opening is located between the first flange and the main body and extends circumferentially along a first segment of the upper cover, and the second opening is located on the second flange and extends circumferentially along a second segment of the upper cover, and further wherein the first segment and the second segment are circumferentially offset from one another.

10. The vent valve of claim 1, wherein the main body further comprises an engagement portion extending circumferentially outward between the first end and the second end, and the engagement portion comprises a first connection face for connecting an airtightness testing fixture.

11. The vent valve of claim 10, wherein,
the main body further comprises:
a support portion located on a first side of the engagement portion and configured to connect the breathable membrane; and
a connection portion located on a second side of the engagement portion; and
the breathable membrane includes:
a first state, in which the breathable membrane conforms to the support portion and seals the through hole; and
a second state, in which the breathable membrane disengages from the through hole.

12. The vent valve of claim 11, wherein,
the support portion comprises:
a second fluid passage directly communicating the through hole with the second opening in the second state;
a first support portion comprising multiple holes;
a second support portion surrounding the first support portion and smoothly transitioning outward; and
a third support portion surrounding the second support portion and comprising the second fluid passage; and
wherein, in the first state, the breathable membrane conforms to the first support portion and the second support portion and is connected to the third support portion;
wherein, in the second state, the breathable membrane is relatively separated from the first support portion and the second support portion, thereby the second fluid passage directly communicates the through hole with the second opening.

13. The vent valve of claim 1, wherein a first flange of the upper cover and a baffle of the vent valve form a staggered shield for protecting the breathable membrane while allowing airflow between the first opening and the second opening.

14. The vent valve of claim 1, wherein the first end of the main body comprises a mesh support frame for supporting the breathable membrane, and the second end of the main body is connected to a protective plate comprising a plurality of holes.

15. The vent valve of claim 1, wherein the first opening and the second opening each include either a continuous circumferential opening or multiple discontinuous openings that are spaced apart from each other.

16. A vent valve, comprising:
a main body comprising:
a first end;
a second end;
a through hole extending from the first end to the second end; and
an engagement portion located between the first end and the second end and extending circumferentially outward, wherein the engagement portion comprises a first connection face for connecting an airtightness testing fixture;
a breathable membrane connected to the main body; and
an upper cover covering the breathable membrane.

17. The vent valve of claim 16, comprising a first opening and a second opening in fluid communication with each other, wherein the first opening and the second opening are offset in at least one of an axial direction or a circumferential direction of the vent valve.

18. The vent valve of claim 17, wherein the first opening is located between a first flange of the upper cover and the main body, and the second opening is located on an end of a baffle that is arranged radially inward of the first opening.

19. The vent valve of claim 17, wherein the first opening is located between a first flange of the upper cover and the main body, and the second opening is located between a second flange of the main body and a cover body of the upper cover.

20. The vent valve of claim 17, wherein the first opening is located between a first flange of the upper cover and the main body and extends circumferentially along a first segment of the upper cover, and the second opening is located on a baffle or on a second flange of the main body and extends circumferentially along a second segment of the upper cover.
